(19) United States
(12) Patent Application Publication
(10) Pub. No.: US 2025/0309431 A1
(43) Pub. Date: Oct. 2, 2025

(54) VEHICLE BATTERY HOUSING WITH INTEGRATED SIDE FRAME

(71) Applicant: TOYOTA MOTOR ENGINEERING & MANUFACTURING NORTH AMERICA, INC., Plano, TX (US)

(72) Inventors: David R. Eilken, Ann Arbor, MI (US); Jason R. Cremer, Stockbridge, MI (US)

(73) Assignees: TOYOTA MOTOR ENGINEERING & MANUFACTURING NORTH AMERICA, INC., Plano, TX (US); TOYOTA JIDOSHA KABUSHIKI KAISHA, Aichi-ken (JP)

(21) Appl. No.: 18/623,638

(22) Filed: Apr. 1, 2024

(51) Int. Cl. H01M 50/24; B60K 1/00; B60K 1/04; B60L 50/60; H01M 10/613; H01M 10/625; H01M 50/204; H01M 50/262; H01M 50/271

(52) U.S. Cl. CPC H01M 50/24; B60L 50/60; H01M 10/613; H01M 10/625; H01M 50/204; H01M 50/262; H01M 50/271; B60K 2001/005; B60K 1/04; B60K 2001/0438; H01M 2220/20

(57) ABSTRACT

An energy storage system includes a vehicle and a battery pack disposed within the vehicle. The battery pack includes a number of battery cells and a housing surrounding the battery cells. The housing includes an upper housing cover, a lower housing cover, an end plate, and a side frame coupled to the upper housing cover by an upper sealing flange of the side frame, and coupled to the lower housing cover by a lower sealing flange of the side frame. A majority of the volume of the end plate fits within a recess of the side frame, such that a majority of the volume of the side frame, upper sealing flange, lower sealing flange, and end plate is stacked vertically.

### TECHNICAL FIELD

The subject matter described herein relates to a side frame for the traction battery of an electric or electrified vehicle. This integrated side frame has particular but not exclusive utility for battery electric vehicles (BEVs), plug-in hybrid electric vehicles (PHEVs), and hybrid electric vehicles (HEVs).

### BACKGROUND

The capacity of large batteries can be measured in kilowatt-hours (kWh). Large (e.g., 0.5 kWh-100 kWh) traction battery packs are used in battery electric vehicles (BEVs), plug-in hybrid electric vehicles (PHEVs), hybrid electric vehicles (HEVs), and range-extended electric vehicles (REEVs). The battery pack includes a plurality of battery modules, each of which includes a plurality of battery cells. Energy density is extremely important in electric vehicle batteries, but much of the space used by the battery structure does not contain any energy storage.

The battery pack includes a housing, at least two sides of which include a module end plate, case side frame, and sealing flange(s), which are traditionally stacked horizontally. However, the volume taken up by the end plate, side frame(s), and sealing flange(s) precludes there being any battery cells in this space, thus leading to lower energy density. Thus, the battery pack includes non-energy-storage portions that add mass and volume to the battery pack without contributing to the storage capacity of the battery pack. Accordingly, a need exists for improved battery pack housings that address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is an integrated side frame for a vehicle traction battery pack housing that increase energy density of battery pack by reducing the non-energy containing space at the sides. The integrated side frame combines the functions of a side frame, end plate or module end, and sealing flange in a small volume. The side frame and end plate are sized and shaped such that the end plate nests with the side frame. The integrated side frame is then affixed to the battery pack upper housing and battery pack lower housing to form a sealed housing or enclosure to contain the battery modules. The integrated side frame disclosed herein has particular, but not exclusive, utility for battery electric vehicles (BEVs), plug-in hybrid electric vehicles (PHEVs), and hybrid electric vehicles (HEVs).

One general aspect includes an energy storage system. The energy storage system includes a vehicle and a battery pack disposed within the vehicle which may include: a plurality of battery cells and a housing surrounding the battery cells. The housing may include: an upper housing cover; a lower housing cover; an end plate; and a side frame coupled to the upper housing cover by an upper sealing flange of the side frame and coupled to the lower housing cover by a lower sealing flange of the side frame, where a majority of the volume of the end plate fits within a recess of the side frame, such that a majority of the volume of the side frame, upper sealing flange, lower sealing flange, and end plate is stacked vertically.

Implementations may include one or more of the following features. In some embodiments, the side frame may include a lower module mount, where the end plate is attached to the side frame within the recess of the side frame by a bolt passing through the lower module mount and into a threaded bolt hole of the end plate. In some embodiments, the upper sealing flange is coupled to the upper housing cover by a fastener. In some embodiments, the side frame may include an external flange bolt channel not in fluid communication with the recess, such that leakage of a fluid around the fastener does not result in the fluid entering the recess. In some embodiments, the lower sealing flange is coupled to the lower housing cover by a weld. In some embodiments, the end plate includes nesting features and the side frame includes complementary nesting features, such that the end plate nests within the recess. In some embodiments, the energy storage system may include a battery cooling system positioned between the battery cells and the lower housing cover. Implementations of the described techniques may include hardware, a method or process, or computer software on a computer-accessible medium.

One general aspect includes an energy storage device that includes a battery pack for a vehicle. The battery pack may include a plurality of battery cells and a housing surrounding the battery cells. The housing may include: an upper housing cover; a lower housing cover; an end plate; and a side frame coupled to the upper housing cover by an upper sealing flange of the side frame and coupled to the lower housing cover by a lower sealing flange of the side frame, where a majority of the volume of the end plate fits within a recess of the side frame, such that a majority of the volume of the side frame, upper sealing flange, lower sealing flange, and end plate is stacked vertically.

Implementations may include one or more of the following features. In some embodiments, the side frame may include a lower module mount, where the end plate is attached to the side frame within the recess of the side frame by a bolt passing through the lower module mount and into a threaded bolt hole of the end plate. In some embodiments, the upper sealing flange is coupled to the upper housing cover by a fastener. In some embodiments, the side frame may include an external flange bolt channel not in fluid communication with the recess, such that leakage of a fluid around the fastener does not result in the fluid entering the recess. In some embodiments, the lower sealing flange is coupled to the lower housing cover by a weld. In some embodiments, the end plate includes nesting features and the side frame includes complementary nesting features, such that the end plate nests within the recess. In some embodiments, the energy storage device may include a battery cooling system positioned between the battery cells and the lower housing cover. Implementations of the described techniques may include hardware, a method or process, or computer software on a computer-accessible medium.

One general aspect includes an energy storage method that includes assembling a battery pack for a vehicle, by: positioning a plurality of battery cells over a lower housing cover positioning an end plate within a side frame such that a majority of the volume of the end plate fits within a recess of the side frame, where the side frame may include an upper sealing flange and a lower sealing flange configured such that a majority of the volume of the side frame, upper sealing flange, lower sealing flange, and end plate is stacked vertically; coupling the lower flange to the lower housing cover; and coupling an upper housing cover to the upper flange.

Implementations may include one or more of the following features. In some embodiments, the side frame may include a lower module mount, where the end plate is attached to the side frame within the recess of the side frame by a bolt passing through the lower module mount and into a threaded bolt hole of the end plate. In some embodiments, the upper sealing flange is coupled to the upper housing cover by a fastener. In some embodiments, the side frame may include an external flange bolt channel not in fluid communication with the recess, such that leakage of a fluid around the fastener does not result in the fluid entering the recess. In some embodiments, the lower sealing flange is coupled to the lower housing cover by a weld. In some embodiments, the end plate includes nesting features and the side frame includes complementary nesting features, such that the end plate nests within the recess. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the integrated side frame, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a top side perspective view of a battery electric vehicle (BEV), in accordance with at least one embodiment of the present disclosure.

FIG. 2 is an exploded view of an electric vehicle traction battery pack, in accordance with at least one embodiment of the present disclosure.

FIG. 3 is a side cross-sectional view of a battery module, in accordance with at least one embodiment of the present disclosure.

FIG. 4 is a top front perspective cross-sectional view of a vehicle, in accordance with at least one embodiment of the present disclosure.

FIG. 5 is a front cross-sectional view of a vehicle, in accordance with at least one embodiment of the present disclosure.

FIG. 6 is a front cross-sectional view of at least a portion of a vehicle, in accordance with at least one embodiment of the present disclosure.

FIG. 7 is a perspective view of a portion of a traction battery pack, in accordance with at least one embodiment of the present disclosure.

FIG. 8 is a front cross-sectional view of a traction battery pack, in accordance with at least one embodiment of the present disclosure.

FIG. 9 is a front cross-sectional view of a traction battery pack, in accordance with at least one embodiment of the present disclosure.

FIG. 10 is a front cross-sectional view of at least a portion of an improved traction battery pack, in accordance with at least one embodiment of the present disclosure.

FIG. 11 is a front cross-sectional view of the integrated side frame and sealing cap and end plate of FIG. 10, in accordance with at least one embodiment of the present disclosure.

FIG. 12 is a front side perspective view of an example battery pack assembly process, in accordance with at least one embodiment of the present disclosure.

FIG. 13 is a front side perspective view of an example battery pack assembly process, in accordance with at least one embodiment of the present disclosure.

FIG. 14A is a front cross-sectional view of an example cross-spacer of a traction battery pack, in accordance with at least one embodiment of the present disclosure.

FIG. 14B is a top side perspective view of an example cross-spacer of a traction battery pack, in accordance with at least one embodiment of the present disclosure.

FIG. 14C is a right-side view of an example integrated side frame and sealing cap, in accordance with at least one embodiment of the present disclosure.

### DETAILED DESCRIPTION

In accordance with at least one embodiment of the present disclosure, a vehicle traction battery pack integrated side frame is provided that combines the functions of a side frame, end plate, and sealing flange in a small volume. The side frame and end plate are sized and shaped such that the end plate nests with the side frame, with little of the volume of the end plate projecting beyond the boundaries of the side frame. The side frame is then welded, bolted, or otherwise affixed to the battery pack upper housing and battery pack lower housing to form a sealed housing or enclosure to contain the battery modules.

This change vertically integrates all three key components (side frame, end plate, and sealing flange) to generate the smallest possible non-energy containing space. The geometry is defined so as to nest the end plate, sealing flange, and case side frame together, which can increase energy density by more than 10%, with no cell innovation required.

The present disclosure aids substantially in electric vehicle design, by improving the space efficiency of the battery pack. Implemented as a physical change to the battery pack housing, the integrated side frame disclosed herein provides practical, physical, and mechanical benefits to the vehicle. This improved housing form factor transforms a battery pack with significant non-energy-storage spaces into one that stores more energy, without the normally routine need to increase the volume of the battery. This unconventional approach improves the functioning of the vehicle, by permitting the battery pack to have a larger number of battery cells for the same volume, or a smaller volume for the same number of battery cells.

These descriptions are provided for exemplary purposes only, and should not be considered to limit the scope of the integrated side frame. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

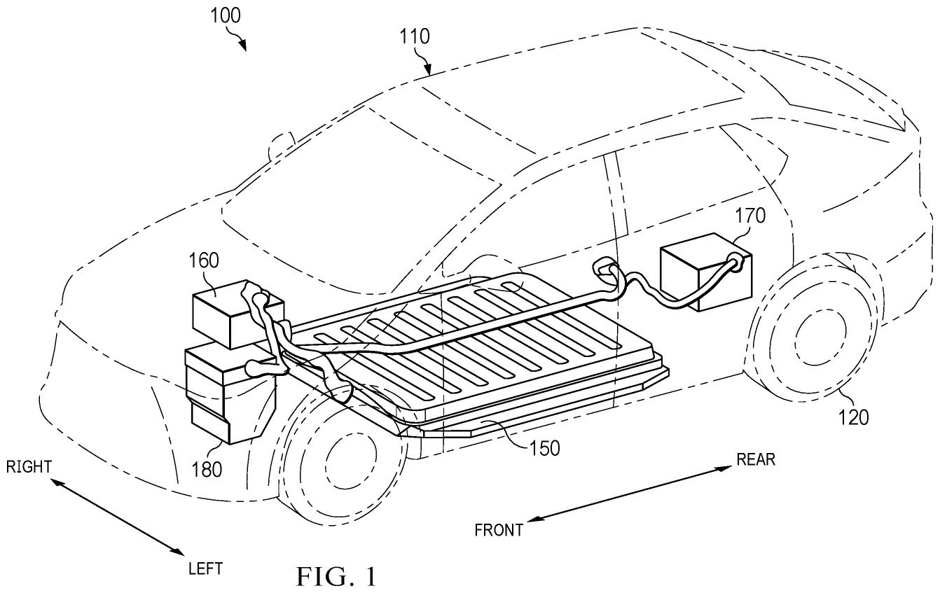

FIG. 1 is a top side perspective view of a battery electric vehicle (BEV) 100, in accordance with at least one embodiment of the present disclosure. The BEV 100 incudes a body 110, wheels 120, a traction battery pack 150, battery management system 160, rear traction motor 170, and front traction motor 180. In most current vehicle designs, the traction battery pack 150 is broad, flat, and located near the bottom of the vehicle in a skateboard configuration. At least some of the same components may be found in plug-in hybrid electric vehicles (PHEVs) and hybrid electric vehicles (HEVs). The vehicle 100 with battery pack 150 may be considered an energy storage system.

Before continuing, it should be noted that the examples described above are provided for purposes of illustration, and are not intended to be limiting. Other devices and/or device configurations may be utilized to carry out the operations described herein.

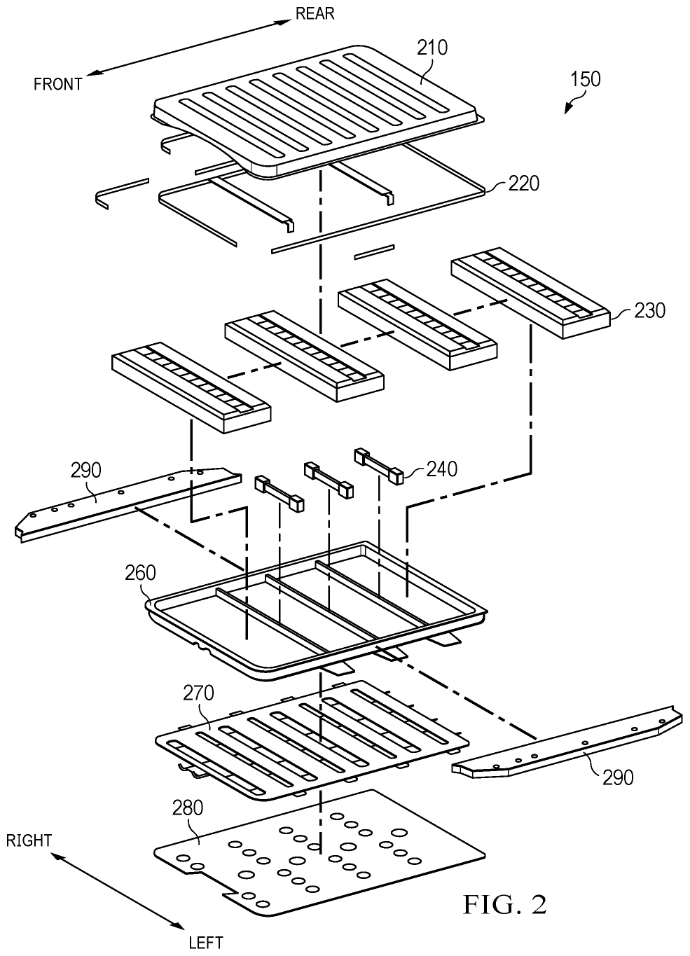

FIG. 2 is an exploded view of an electric vehicle traction battery pack 150, in accordance with at least one embodiment of the present disclosure. In the example shown in FIG. 2, the battery pack 150 includes an upper housing cover 210, wiring 220, battery modules 230, spacers 240, extrusions 290, battery module holding tray or lower case 260, cooling system 270, and lower housing cover 280. It is understood that, depending on the implementation, the battery pack 150 may include additional features, and/or some of the features shown in FIG. 2 may be absent or arranged differently, without departing from the spirit of the present disclosure.

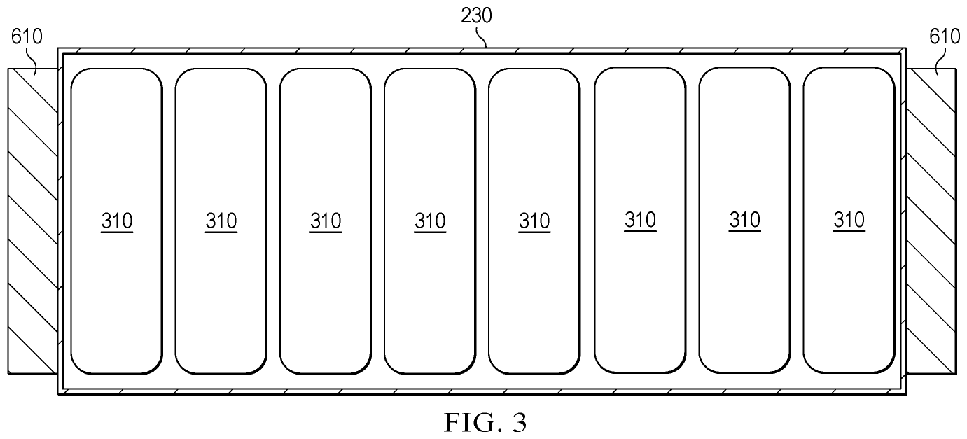

FIG. 3 is a side cross-sectional view of a battery module 230, in accordance with at least one embodiment of the present disclosure. The mattery module 230 includes a plurality of cells 310, which may be wired together in series, in parallel, or combinations thereof, depending on the implementation. For example, higher voltage may be achieved by wiring the cells in series, whereas higher capacity at lower voltage may be achieved by wiring the cells together in parallel. The number of cells 310 per module 230, as well as the dimensions of each cell 310 and the module 230, may be different than shown in FIG. 3 without departing from the spirit of the present disclosure. The cells 310 may be prismatic, cylindrical, pouch, blade, or any other type or form factor. Also visible are the end plates or module ends 610.

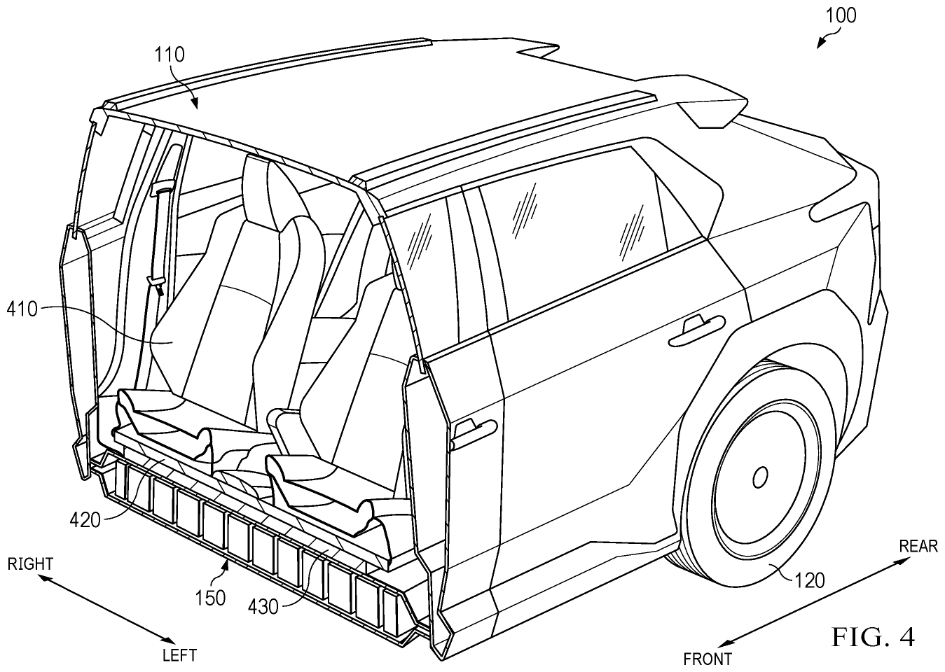

FIG. 4 is a top front perspective cross-sectional view of a vehicle 100, in accordance with at least one embodiment of the present disclosure. Visible are the body 110 and a wheel 120. Also visible are seats 410, a cabin floor 420, and at least a portion of the traction battery pack 150, which is situated below an air gap 430.

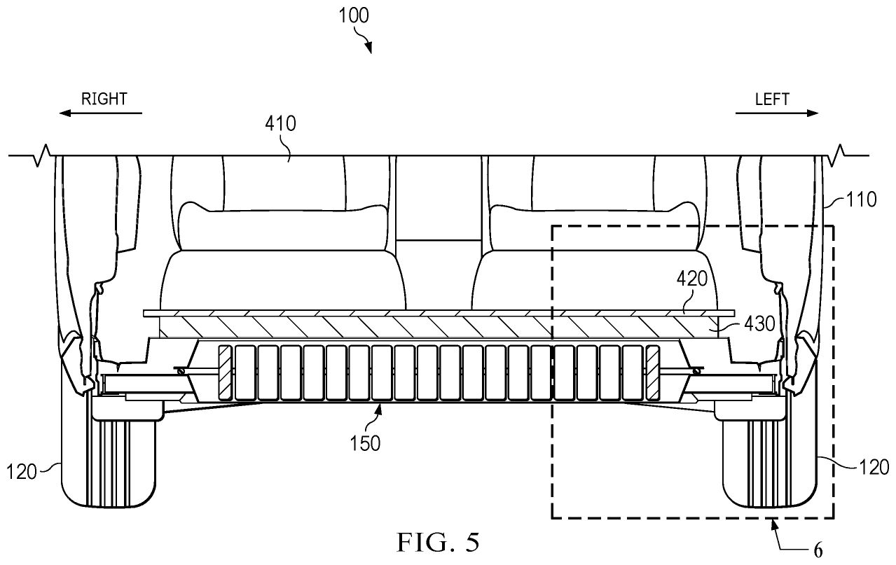

FIG. 5 is a front cross-sectional view of a vehicle 100, in accordance with at least one embodiment of the present disclosure. Visible are the body 110 and two wheels 120. Also visible are seats 410, a cabin floor 420, and at least a portion of the traction battery pack 150, which is situated below the air gap 430.

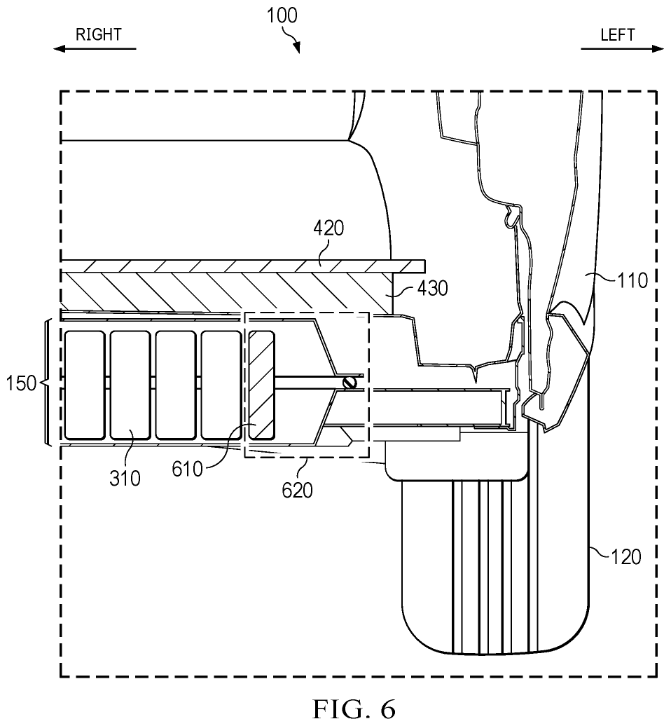

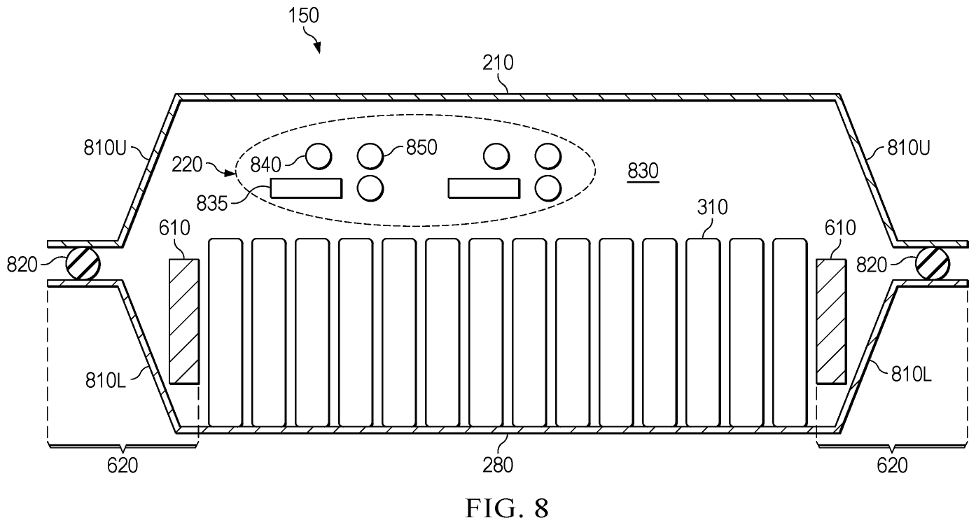

FIG. 6 is a front cross-sectional view of at least a portion of a vehicle 100, in accordance with at least one embodiment of the present disclosure. Visible are the body 110 and a wheel 120. Also visible is the cabin floor 420, and at least a portion of the traction battery pack 150, which is situated below the air gap 430. The battery pack 150 includes a number of cells 310, an end plate or module end 610, and a non-energy-storage space 620, which includes the end plate or module end 610 and other features, as shown below in FIG. 8.

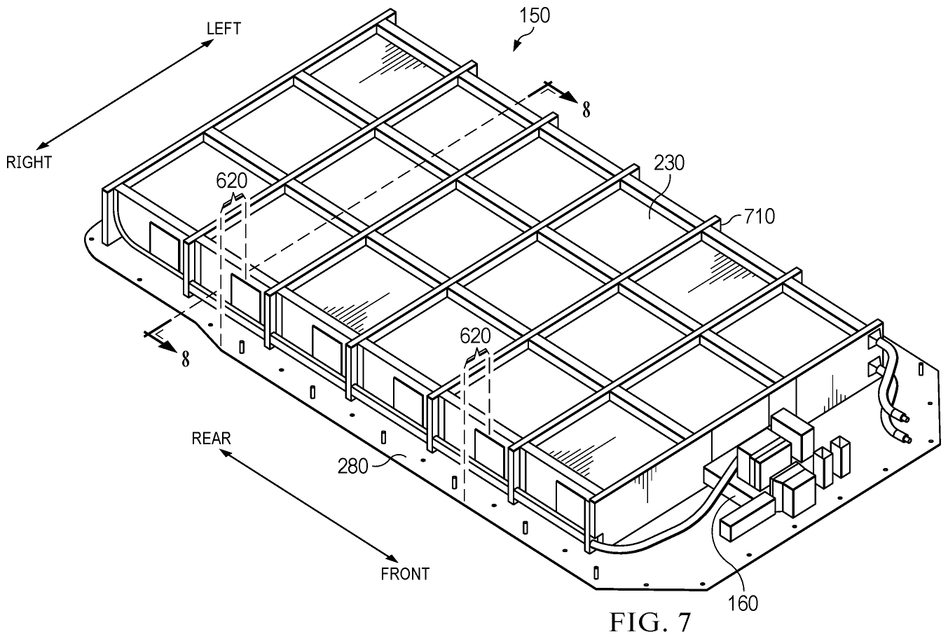

FIG. 7 is a perspective view of a portion of a traction battery pack 150, in accordance with at least one embodiment of the present disclosure. Visible are the battery management system 160 and battery modules 230 separated by cross spacers 710, positioned on the lower housing cover 280. Also visible is the non-energy-storage volume 620. A cross-section line 8-8 shows where the cross-section of FIG. 8 is taken.

FIG. 8 is a front cross-sectional view of a traction battery pack 150, in accordance with at least one embodiment of the present disclosure. The battery pack 150 includes an upper housing cover 210, lower housing cover 280, a plurality of cells 310, and an air space 830 which includes wiring 220 such as one or more bus bars 835, one or more sensors or sensor wires 840, and one or more signal wires 850. The battery pack 1650 also includes two end plates or module ends 610, which are held against the cells 310 by respective upper side frames 810U, lower side frames 810L, and sealing flanges 820. The side frames 810U, 810L, end plates 610, and sealing flanges 820 collectively form non-energy-storage volumes 620, which add to the volume of the battery pack 150 but do not contain any battery cells 310.

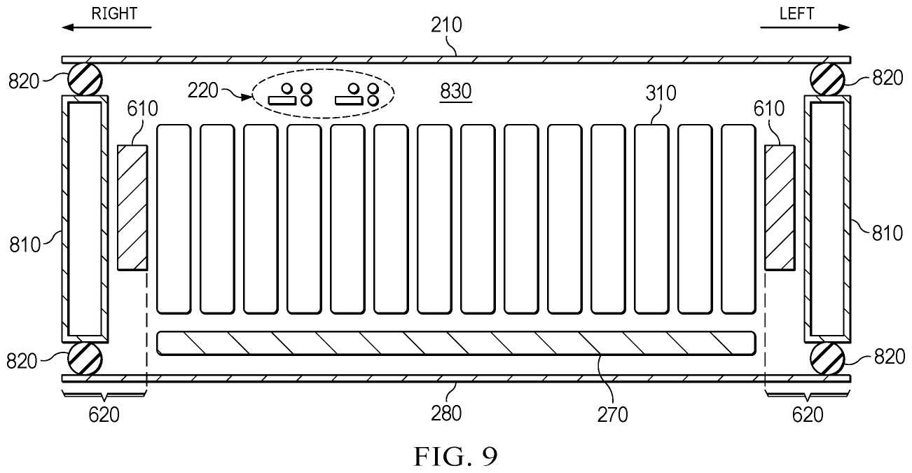

FIG. 9 is a front cross-sectional view of a traction battery pack 150, in accordance with at least one embodiment of the present disclosure. Visible are the upper housing cover 210, air space 830, wiring 220, cells 310, lower housing cover 280, and cooling system 270. The battery pack 150 of FIG. 9 is similar to that of FIG. 8, except that on each side of the battery pack 150, the upper and lower side frames have been replaced with a single vertical side frame 810, sealed in place with two sealing flanges 820 to hold the end plate or module end 610 against the battery cells 310. In this configuration, the sealing flanges are stacked on top of the side frame to reduce wasted space. Additionally, the side frame is made vertical to eliminate any draft loss due to angled surfaces. However, this still leaves substantial non-energy-storage volumes 620 on the left and right sides of the cell, as well as the air space 830 above the cells 310.

It is noted in roughly 20% of vehicles, the battery pack is rotated ±90 degrees from the configuration shown herein, such that the left and right sides of the battery become the front and rear of the battery, or vice-versa. Such configurations nevertheless fall explicitly within the scope of the present disclosure.

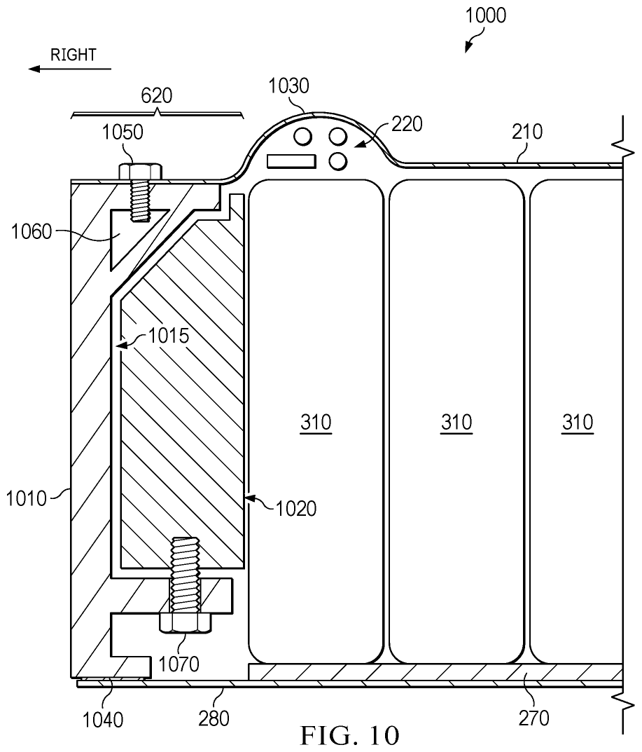

FIG. 10 is a front cross-sectional view of at least a portion of an improved traction battery pack or energy storage system 1000, in accordance with at least one embodiment of the present disclosure. Visible are the upper housing cover 210, wiring 220, cells 310, lower housing cover 280, and cooling system 270. The battery pack 1000 of FIG. 10 is similar to the batter pack 150 of FIG. 9, except that the side frame 1010 now attaches directly to the upper housing cover 210 and lower housing cover 280, without a separate sealing flange. One effect of this is the elimination of the air space 830 above the cells 310. Instead, the wiring 220 is positioned within a raised electrical channel 1030 in the upper housing cover 210. This has the effect of reducing the volume of the battery pack 1000 vs. that of the battery pack 150 of FIG. 9, for the same number of battery cells 310. However, in some embodiments, the air space 830 may be included.

Furthermore, the side frame 810 of FIG. 9 has been replaced with an integrated side frame and sealing cap 1010, which includes a recess 1015 sized and shaped to receive the end plate or module end 1020. The end plate or module end 1020 is sized and shaped such that a majority of its volume (e.g., 80-90% of its volume, although other amounts both larger and smaller may be used instead or in addition) fits within the recess 1015 of the integrated side frame 1010. Thus, the side frame 1010, end plate 1020, and sealing flange (or a majority of the volumes thereof) are all stacked vertically rather than horizontally, thus creating ultra-efficient packaging for the battery pack.

This nesting of the side frame 1010 and the end plate 1020 reduces the size of the non-energy-storage volume 620 by approximately 17.6% over what is shown in FIG. 8, and by approximately 4.8% over what is shown in FIG. 9, for an overall energy density increase of 13%. This dramatic reduction in the non-energy-storage volume 620 means that either the battery pack 1000 can be smaller than the battery pack 150, while holding the same number and size of battery cells 310, or else the battery pack 1000 can hold more cells than the battery pack 150, while retaining the same overall volume. In some instances, the battery pack 1000 may be smaller and have more cells. Other combinations of size and capacity, as would occur to a person of ordinary skill in the art, are also possible and explicitly fall within the scope of the present disclosure.

In the example shown in FIG. 10, the integrated side frame and sealing cap 1010 attaches to the lower housing cover 280 by means of a weld 1040 (e.g., a friction stir weld, although other types of welds may be used instead or in addition, including but not limited to MIG, TIG, solder, brazing, etc.). Similarly, the integrated side frame and sealing cap 1010 attaches to the upper housing cover with a fastener 1050 that may protrude partway into an external flange bolt channel 1060, and the end plate 1020 attaches to the integrated side frame and sealing cap 1010 with a fastener 1070. In an example, the fasteners 1050 and 1070 are bolts, although other types of fasteners may be used instead or in addition, including but not limited to screws, rivets, pins, expanding fasteners, etc. It is also understood that, depending on the implementation, a fastener may be used in place of the weld 1040, and/or welds may be used in place of either or both of the fasteners 1050 and 1070.

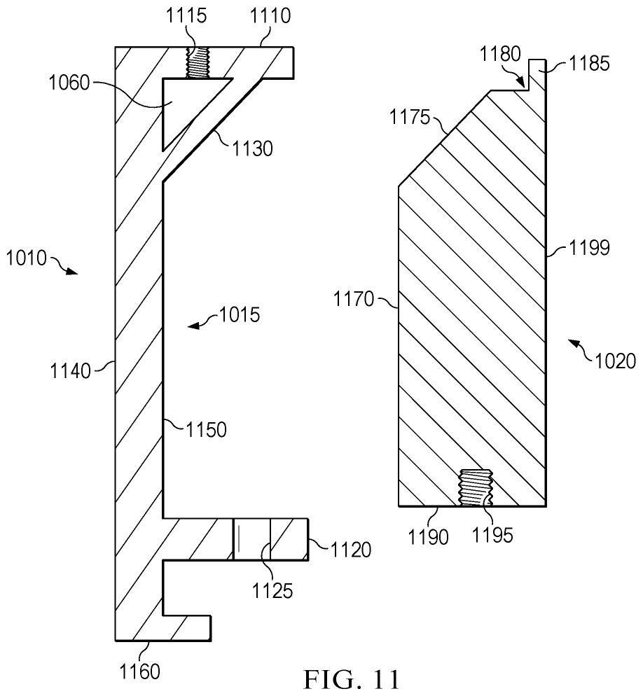

FIG. 11 is a front cross-sectional view of the integrated side frame and sealing cap 1010 and end plate 1020 of FIG. 10, in accordance with at least one embodiment of the present disclosure. The integrated side frame and sealing cap 1010 includes an upper sealing flange 1110 with through-hole 1115, and a lower module mount 1120 with through-hole 1125. Depending on the implementation, the through-holes 1115 and 1125 may be threaded, unthreaded, or combinations thereof. The integrated side frame and sealing cap 1010 also includes an outer surface 1140, as well as an inner surface 1150, and a diagonal support spar 1130. Together, the inner surface 1150, diagonal support spar 1130, and lower module mount 1120 define a recess 1015 which is sized and shaped to receive the end plate or module end 1020. The integrated side frame and sealing cap 1010 also includes a lower sealing flange 1160, which can be welded to the lower housing cover.

The external flange bolt channel 1060 may be isolated from the interior of the battery pack housing, such that any fluid leakage around the bolts (e.g., around the edges of the through-holes 1115) winds up in the external flange bolt channel 1060, rather than inside the battery pack.

The end plate or module end 1020 includes an outer surface 1170, diagonal nesting surface 1175, nesting groove 1180, and bottom surface 1190, which are collectively configured to fit within, and be received by, the recess 1015. The bottom surface 1190 includes a threaded bolt hole 1195, by which the end plate 1020 can be attached to the lower module mount 1120 via a bolt passing through the through-hole 1125. The end plate 1020 also includes a nesting spar 1185 and inner surface 1199, which collectively make contact with the battery cells.

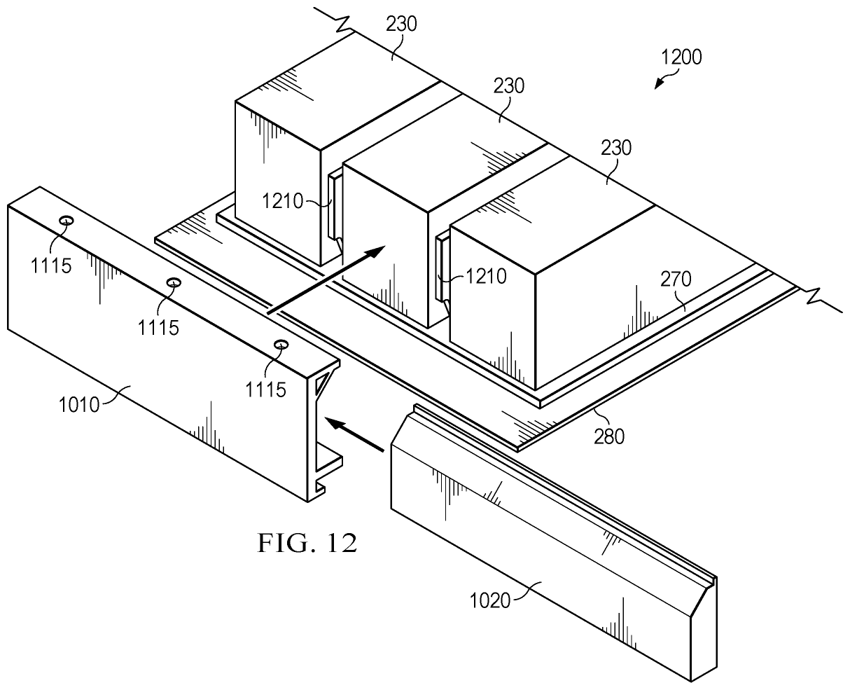

FIG. 12 is a front side perspective view of an example battery pack assembly process 1200, in accordance with at least one embodiment of the present disclosure. Traditionally, assembly of battery packs involves building the housing and then inserting the battery modules into the housing. The battery pack assembly process 1200 instead involves building the housing around the modules. In the example shown in FIG. 12, battery modules 230 are lined up with cross spacers 1210 on top of the lower housing cover 280 and cooling system 270, and then the end plate or module end 1020 and integrated side frame and sealing cap 1010 are moved into position as shown. The end plate or module end 1020 is then bolted to the integrated side frame and sealing cap 1010, and the integrated side frame and sealing cap 1010 is welded to the lower housing cover 280.

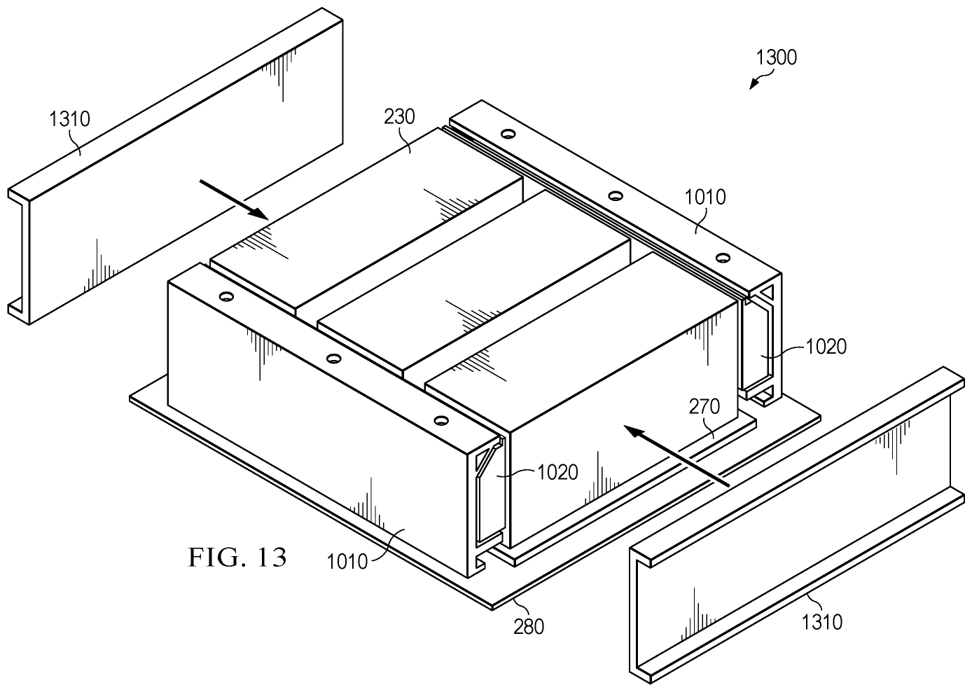

FIG. 13 is a front side perspective view of an example battery pack assembly process 1300, in accordance with at least one embodiment of the present disclosure. In the example shown in FIG. 13, once the end plates 1020 and integrated side frame and sealing caps 1010 are assembled to the battery modules 230 and lower housing cover 280, front and rear end covers 1310 are then attached to the integrated side frames and sealing caps 1010 by welds 1040. In an example, the welds are friction stir welds, although other types of welds may be used instead or in addition, including but not limited to MIG, TIG, solder, brazing, etc. The assembly process 1300 may for example incorporate a corner sealing process.

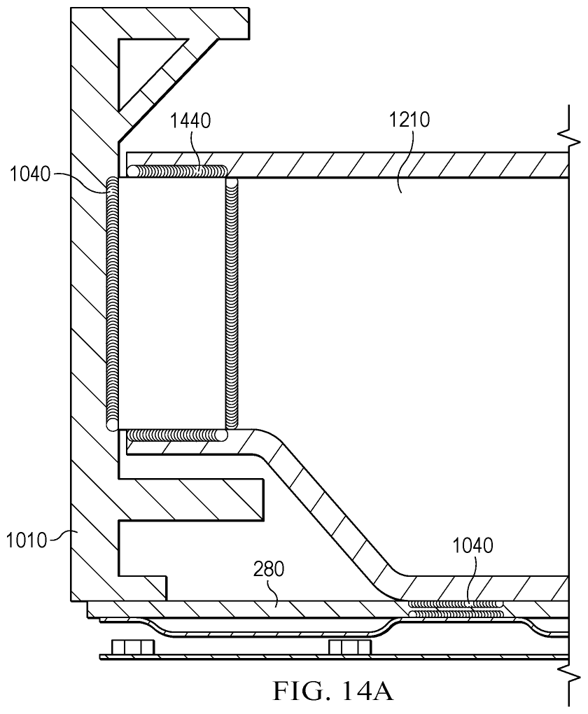

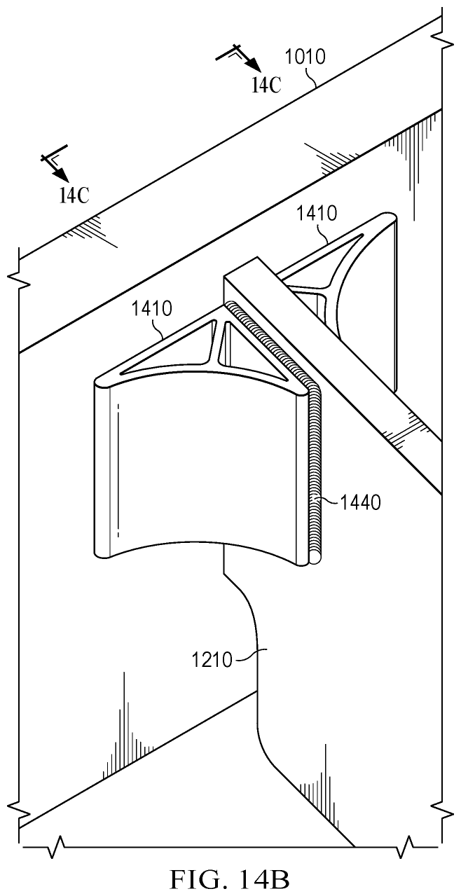

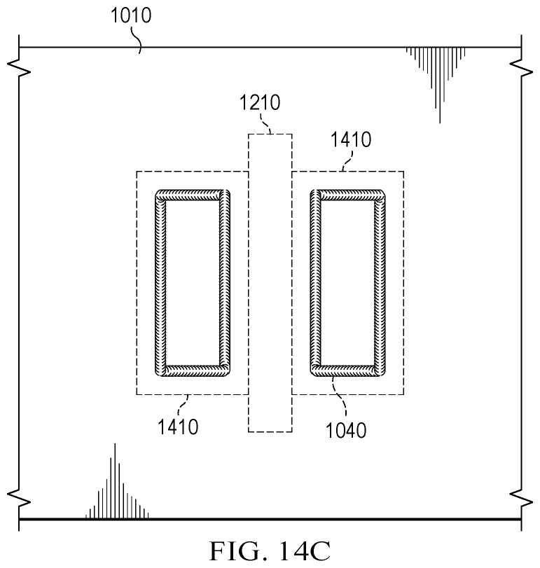

FIG. 14A is a front cross-sectional view of an example cross-spacer 1210 of a traction battery pack, in accordance with at least one embodiment of the present disclosure. In the example shown in FIG. 14A, the cross-spacer 1210 is attached to the integrated side frame and sealing cap 1010, and to the lower housing cover 280, by welds 1040. In an example the welds 1040 are friction stir welds, although other types of welds could be used instead or in addition. The cross-spacer 1210 also includes attachment flanges 1410 (see FIG. 14B), which are attached to the cross-spacer 1210 by welds 1440. In an example, the welds 1440 are MIG welds, although other types of welds may be used instead or in addition.

FIG. 14B is a top side perspective view of an example cross-spacer 1210 of a traction battery pack, in accordance with at least one embodiment of the present disclosure. Visible are the cross-spacer 1210 and the attachment flanges 1410, which are held to the cross-spacer by the welds 1440, and which are attached to the integrated side frame and sealing cap 1010 by the welds 1040 (see FIGS. 14A and 14C).

FIG. 14C is a right-side view of an example integrated side frame and sealing cap 1010, in accordance with at least one embodiment of the present disclosure. Visible as hidden lines are the cross-spacer 1210 and attachment flanges 1410. The attachment flanges 1410 are attached to the integrated side frame and sealing cap 1010 by welds 1040. In an example, the welds are friction stir welds, although other types of welds may be used instead or in addition. Friction stir welding may be considered low-hazard welding, as it can minimize local temperature increases associated with welding that could potentially damage the battery cells or lead to thermal runaway. Friction stir welding may thus be particularly suitable for assembling components that sit adjacent to the installed battery modules.

As will be readily appreciated by those having ordinary skill in the art after becoming familiar with the teachings herein, the present disclosure provides devices, systems, and methods for reducing the volume and/or increasing the energy storage capacity of electric vehicle traction battery packs. Accordingly, it can be seen that the integrated side frame of the present disclosure fills a long-standing need in the art, by combining the functions of the end plate, side frame, and sealing flange(s) into a single, smaller volume. These improvements dramatically reduce the amount of non-energy-storage volume in the battery pack.

A number of variations are possible on the examples and embodiments described above. For example, the exact shape and size of the side frame and end plate may be different than shown herein, while preserving the nesting property that places a majority of the volume of the end plate within a recess of the side frame.

The technology described herein may be applied to battery electric vehicles (BEVs), plug-in hybrid electric vehicles (PHEVs), and hybrid electric vehicles (HEVs). It may be applied to cars, trucks, motorcycles, aircraft, and watercraft, as well as architectural (e.g., home and business) energy storage batteries of any cell size, cell shape, or cell chemistry.

The logical operations making up the embodiments of the technology described herein are referred to variously as operations, steps, objects, elements, components, or modules. Furthermore, it should be understood that these may be occur, or performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the integrated side frame. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the integrated side frame as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. An energy storage system, comprising:
a vehicle;
a battery pack disposed within the vehicle and comprising:
a plurality of battery cells;
a housing surrounding the battery cells and comprising:
an upper housing cover;
a lower housing cover;
an end plate; and
a side frame coupled to the upper housing cover by an upper sealing flange of the side frame and coupled to the lower housing cover by a lower sealing flange of the side frame,
wherein a majority of the volume of the end plate fits within a recess of the side frame,
such that a majority of the volume of the side frame, upper sealing flange, lower sealing flange, and end plate is stacked vertically.

2. The energy storage system of claim 1, wherein the side frame comprises a lower module mount, wherein the end plate is attached to the side frame within the recess of the side frame by a bolt passing through the lower module mount and into a threaded bolt hole of the end plate.

3. The energy storage system of claim 1, wherein the upper sealing flange is coupled to the upper housing cover by a fastener.

4. The energy storage system of claim 3, wherein the side frame comprises an external flange bolt channel not in fluid communication with the recess, such that leakage of a fluid around the fastener does not result in the fluid entering the recess.

5. The energy storage system of claim 1, wherein the lower sealing flange is coupled to the lower housing cover by a weld.

6. The energy storage system of claim 1, wherein the end plate includes nesting features and wherein the side frame includes complementary nesting features, such that the end plate nests within the recess.

7. The energy storage system of claim 1, further comprising a battery cooling system positioned between the battery cells and the lower housing cover.

8. An energy storage device, comprising:
a battery pack for a vehicle, the battery pack comprising:
a plurality of battery cells;
a housing surrounding the battery cells and comprising:
an upper housing cover;
a lower housing cover;
an end plate; and
a side frame coupled to the upper housing cover by an upper sealing flange of the side frame and coupled to the lower housing cover by a lower sealing flange of the side frame,
wherein a majority of the volume of the end plate fits within a recess of the side frame,
such that a majority of the volume of the side frame, upper sealing flange, lower sealing flange, and end plate is stacked vertically.

9. The energy storage device of claim 8, wherein the side frame comprises a lower module mount, wherein the end plate is attached to the side frame within the recess of the side frame by a bolt passing through the lower module mount and into a threaded bolt hole of the end plate.

10. The energy storage device of claim 8, wherein the upper sealing flange is coupled to the upper housing cover by a fastener.

11. The energy storage device of claim 10, wherein the side frame comprises an external flange bolt channel not in fluid communication with the recess, such that leakage of a fluid around the fastener does not result in the fluid entering the recess.

12. The energy storage device of claim 8, wherein the lower sealing flange is coupled to the lower housing cover by a weld.

13. The energy storage device of claim 8, wherein the end plate includes nesting features and wherein the side frame includes complementary nesting features, such that the end plate nests within the recess.

14. The energy storage device of claim 8, further comprising a battery cooling system positioned between the battery cells and the lower housing cover.

15. An energy storage method, comprising:
assembling a battery pack for a vehicle, by:
positioning a plurality of battery cells over a lower housing cover
positioning an end plate within a side frame such that a majority of the volume of the end plate fits within a recess of the side frame,
wherein the side frame comprises an upper sealing flange and a lower sealing flange configured such that a majority of the volume of the side frame, upper sealing flange, lower sealing flange, and end plate is stacked vertically;
coupling the lower flange to the lower housing cover; and
coupling an upper housing cover to the upper flange.

16. The energy storage method of claim 15, wherein the side frame comprises a lower module mount, wherein the end plate is attached to the side frame within the recess of the side frame by a bolt passing through the lower module mount and into a threaded bolt hole of the end plate.

17. The energy method of claim 15, wherein the upper sealing flange is coupled to the upper housing cover by a fastener.

18. The energy method of claim 17, wherein the side frame comprises an external flange bolt channel not in fluid communication with the recess, such that leakage of a fluid around the fastener does not result in the fluid entering the recess.

19. The energy method of claim 15, wherein the lower sealing flange is coupled to the lower housing cover by a weld.

20. The energy storage method of claim 15, wherein the end plate includes nesting features and wherein the side frame includes complementary nesting features, such that the end plate nests within the recess.
